(19) United States
(12) Patent Application Publication
(10) Pub. No.: US 2007/0205321 A1
(43) Pub. Date: Sep. 6, 2007

(54) Speed changing gearbox with dual path input

(75) Inventor: William Martin Waide, Adelanto, CA (US)

Correspondence Address: Rutan & Tucker, LLP.;Hani Z. Sayed, 611 ANTON BLVD, SUITE 1400, COSTA MESA, CA, 92626, US

(73) Assignee: Karem Aircraft, Inc.

(21) Appl. No.: 11/473,978

(22) Filed: Jun. 23, 2006

Related U.S. Application Data
(60) Provisional application No. 60/693,723, filed on Jun. 24, 2005.

(51) Int. Cl. B64C 27/08

(52) U.S. Cl. 244/17.23

(57) ABSTRACT

Contemplated gearboxes provide first and second power-balanced paths in which a speed changer is configured to operate with only one path. Most preferably, the gearbox includes a friction clutch and a sprag clutch arranged such that, together with a layshaft and spur-gear differential, gear shifting can be done while transmitting power.

This application claims the benefit of our U.S. provisional patent application with the Ser. No. 60/693,723, which was filed Jun. 24, 2005.

### FIELD OF THE INVENTION

The field of the invention relates to the transmission of power by gears, and to the provision of a speed changing facility within the gearbox.

### BACKGROUND OF THE INVENTION

There are some instances in the configuration of aircraft where the rotational speed of the propeller, in the case of a fixed wing aircraft, or of the rotor, in the case of a helicopter, has to be changed relative to the speed of the engine. This is because the range of speed of the propeller or rotor required for good efficiency exceeds the permissible speed range of commonly-used turboshaft engines. Hence a two-speed, lightweight reduction gearbox is required. The aircraft type which would benefit from a two-speed propeller drive is a high-altitude, long-endurance machine. Similarly, in the case of rotorcraft or for tilt-rotor aircraft which transition from VTOL (Vertical Take Off and Landing) to wing-born forward flight, the rotor speed is decreased for efficient cruise performance from that required for vertical flight and would therefore also benefit from a two-speed gearbox.

However, where an aircraft becomes relatively large, requiring several thousands of horsepower, the design of the speed-changing gearbox poses significant technical challenges. While the automobile industry routinely employs a multiplicity of speed-changing transmissions, weight is often not critical and transmitted power rarely exceeds 500 horsepower. Unfortunately, known automobile gearboxes fail to yield any useable design which would approach the power-to-weight ratio required in recent highly-efficient aircraft designs that typically demand a flight-weight, two-speed, multi-thousand horsepower-capable, highly-reliable gearbox. Other known gearboxes advantageously transmit power during switching and are known as a “friction clutch/over-running clutch” combination. Here, if a gearset arranged as a planetary set is provided with a clamped friction clutch element between any two of its three rotating members, it will rotate as a body with no reduction ratio. There are two torque-carrying elements and one torque-reacting element in a simple planetary gearset. If the reaction member which normally reacts torque to the transmission casing is provided with a back-stopping or over-running clutch, the gearset will behave as a speed reducer when the friction clutch is free (over-running clutch gripped) and as a direct drive, one-to-one ratio, when the friction clutch is engaged and the over-running clutch over-runs freely. However, when the device is called on to transmit many thousands of foot-pounds of torque, the components, particularly the clutch members, become large and heavy. Gearsets rotating as a body with no relative gear rotation, i.e. with individual gear teeth carrying load but with no mesh action, can suffer tooth contact area degradation, and are therefore not suitable for long-term operation. Therefore, these friction clutch/over-running clutch combinations will typically fail under heavy torque conditions.

In a further example, gas turbine power plants produce power at low weight by virtue of high rotational speeds. Torque is minimized because the speed is high. Similarly, the lightest gearbox will operate at the highest permissible speed, usually controlled by the practical upper limit for the peripheral speed of the gears, which lies between 15,000 and 20,000 feet per minute. However, the operation of a multi-thousand horsepower friction clutch at high rotational speed and the provision of a workable clamping/un-clamping arrangement is a technical challenge unlikely to be met successfully within a strict weight budget for aircraft gearboxes.

Therefore, there is still a need to provide a flight weight, speed-changing gearbox suitable for power transmission well above a thousand horsepower.

### SUMMARY OF THE INVENTION

The inventive subject matter provides devices and methods in which gearboxes combine a speed-changing capability with the capacity for transmitting many thousands of horsepower at a power-to-weight ratio unattainable with heretofore known configurations. More specifically, contemplated devices and methods split a drive into two approximately power-balanced paths, wherein the speed changer is configured to operate only on one path. Most preferably, a friction clutch is arranged, which, by specific arrangement of gears, is the reaction path to the casing or static element of the transmission. Thus, only half of the clutch plate stack has to rotate, and the clamping and actuation system is static, and hence operable by structure-mounted components. the entire friction clutch is required to rotate. In a preferred aspect of the inventive subject matter, the gearbox is configured to transmit power during the speed-changing event, which is desirable for propeller or rotor drives.

It should be especially appreciated that power-dividing gear drives, particularly in rotorcraft, produce a series of benefits which translate into significant weight savings. When gear sizes are reduced (by virtue of splitting the torque from one path to two parallel paths of gear trains), the size not only of the gears but of their support bearings and the surrounding casing is reduced. Moreover, lower peripheral speeds result at the same rotational speed, and efficiency rises. The inventive subject matter integrates the speed-changing facility with the benefits of a dual-path drive.

Various objects, features, aspects and advantages of the present invention will become more apparent from the following detailed description of preferred embodiments of the invention.

### BRIEF DESCRIPTION OF THE DRAWING

FIG. 1 is a top view of a rotorcraft having left and right rotors, engines, and gearboxes, all potentially coupled together.

FIG. 2 is a schematic arrangement of a divided input, load-sharing arrangement of gears with a friction clutch and an over-running clutch.

FIG. 3 is an isometric drawing of the intermeshing planet gears of a dual-input, planet-carrier output differential.

### DETAILED DESCRIPTION

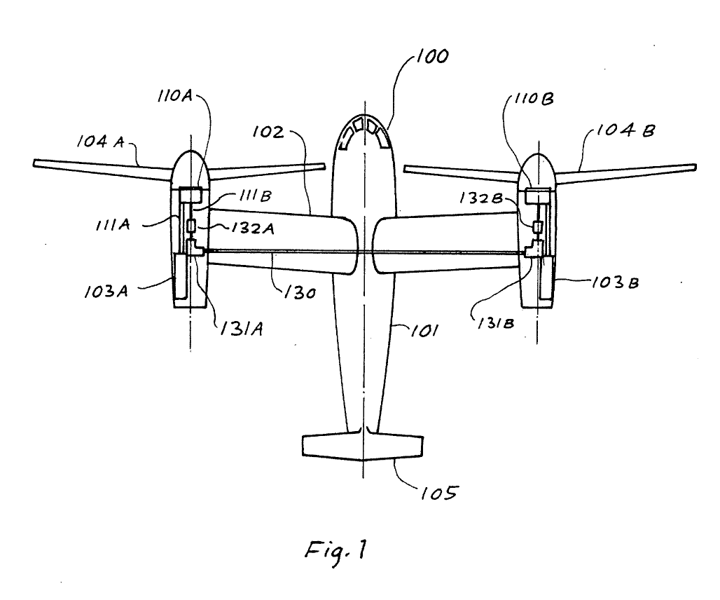

A typical tilt rotor aircraft is depicted in FIG. 1 in which rotorcraft 100 includes fuselage 101, a transverse wing 102, tail 105, left and right engines 103A and 103B, with left and right rotors 104A and 104B, respectively. Left and right gearboxes 110A and 110B are rotatably coupled via cross-wing drive shaft 130, angle drives 131A and 131B, and separable under-load couplings 132A and 132B. Shafts 11A and 11B transmit power from the engines to the rotors. Although the rotorcraft 100 in FIG. 1 is shown as an airplane having two tilt rotors, it should be understood that rotorcraft 100 is emblematic of any sort of vehicle, including fan boats, high speed marine drives, and particularly to vehicles where extreme reliability is important.

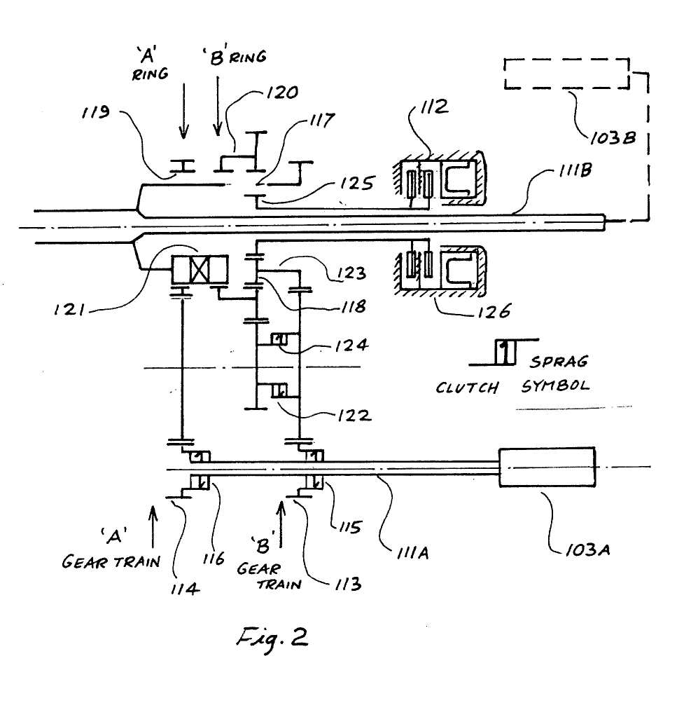

In FIG. 2, the gearbox generally comprises a first input from engine 103A via input shaft 111A, and a second input/output to/from engine 103B via shaft 111B. FIG. 2 shows that the basic arrangement of the input and output sections of the gearbox are parallel and separated from each other. Shaft separation in aircraft installations is convenient for engine mounting purposes. This layshaft arrangement allows for a convenient friction clutch 112 arrangement. It also allows for a rotation direction reversal by introducing an additional layshaft into the arrangement. This would be required, for example, for a two-propeller arrangement where the propellers counter-rotated but the engines ran in the same direction. The illustration shows the input shaft from the prime mover which is most likely a turboshaft engine although other power sources such as a steam turbine or diesel engine would also be applicable. The input shaft 111A carries two gears 113, 114. Shown in the illustration, but not necessary for gearbox function, is an over-running clutch 115, 116 in each gear. This would allow a malfunctioning or inoperative engine to drop “off line” when more than one engine is used to drive the speed changer. When transmitting power, it will be seen that both input gears behave exactly as if rigidly interconnected.

On the output side of the gearbox, it will be seen that the output is driven by a common planet carrier 117, whose planets 118 intermesh with input ring 120. Two ring gears 119, 120 are required for the parallel path, and spur-gear differential 121 is operationally coupled to ring gears 119 and 120. Thus, the two input rings will always be in torque balance, but are free to rotate at differing speeds.

One ring 119 (the “A” gear train) is constantly in mesh with the “A” input pinion 114. The other ring 120 (the “B” gear train) is alternatively driven via its outside surface from a layshaft 122, or from its inside surface from a moderately up-speeding planetary set 123. Inserted in the “B” geartrain layshaft 122 is an over-running sprag clutch 124. The up-speeding planetary 123 is made active by clamping the sun gear 125 to the gearcase 126 using the friction clutch 112. Being the higher speed of the two alternative drives, the sprag clutch 124 then freewheels.

To effect a speed change to a lower output speed, the friction clutch 112 is released, and the drive is then re-asserted through the sprag clutch 124. Thus it will be seen that speed changing in either direction of the ratio step, from slow to fast (friction clutch) or from fast to slow (sprag clutch) is effected by an “either-or” command to the friction clutch 112. Friction clutches can carry torque regardless of the relative rotational speed between the clutch plates. The speed changer is therefore power sustaining during ratio changes, the length of time devoted to the shift event is governed entirely by the thermal capacity of the clutch. For ratio steps of less than 2, and for propeller drives up to 10,000 horsepower, the speed changing event is between three and seven seconds, for example, for a clutch weight of 5% of total gearbox weight.

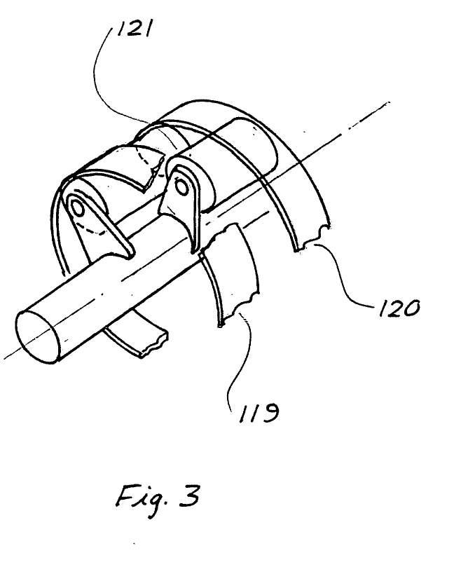

FIG. 3 shows the operation of the two ring driven, carrier output differential 121. From the illustration it will be seen that the device always produces a result that the ring gear inputs are in torque balance, regardless of their rotational speeds. This characteristic is reflected back up the geartrains whether in the high speed load path or the low speed load path. The operating principle is simply stated: the output rings 119, 120 run at equal torque but differing speeds, and the input pinions 113, 114 run at equal speed but differing torque.

Therefore, it should be appreciated that contemplated gearboxes will employ integrated layshaft-type transmission with dual load path. Using such configuration, mesh action at all gear interfaces is ascertained regardless of the speed-changing state in the device. Moreover, devices according to the inventive subject matter allow power-sustained speed-changing using a friction clutch/over-running clutch combination without the disadvantages of heretofore known devices, as among other things, the speed-changing elements are only exposed to a portion of transmitted power. Furthermore, device configurations may be simplified (and with that allow for reduced weight) as the friction clutch with half of friction plate complement is arranged to be non-rotating, and hence operable by case-mounted actuation methods. Most typically, gearboxes according to the inventive subject matter will transmit power from an engine operating at equal or higher than 1000 hp, more typically equal or higher than 2000 hp, and most typically equal or higher than 5000 hp.

Thus, specific embodiments and applications of speed changing gearboxes with dual path input have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A speed changing gearbox having first and second independently and concurrently operational drive paths for transmission of torque.

2. The gearbox of claim 1, further comprising a gearset and associated clutches that are configured to cooperate in a manner to provide a high output speed and alternatively a low output speed.

3. The gearbox of claim 1, further comprising a friction clutch operatively positioned to allow sustained drive torque during a speed changing event.

4. The gearbox of claim 1, further comprising a clutch operatively positioned along the second drive path.

5. The gearbox of claim 4, further comprising a differential that exposes the clutch to a proportion of the torque when the first drive path is carrying a balance of the torque.

6. The gearbox of claim 1, further comprising an input drive connector having a first axis of rotation and an output drive connector having a second axis of rotation, and the first and second axes of rotation are not coaxial.

7. An aircraft having first and second engines powering first and second rotors through first and second gearboxes according to claim 1, respectively.

8. The aircraft of claim 7, further comprising a mechanical link between the gearboxes such that both rotors continue to receive power upon failure of the first engine.

9. The aircraft of claim 7, wherein each of the gearboxes includes an over-running clutch.
